(19) United States
(12) Patent Application Publication
(10) Pub. No.: US 2008/0158411 A1
(43) Pub. Date: Jul. 3, 2008

(54) GOOSENECK VIDEO DEVICE HOLDER

(76) Inventor: Jamey Firnberg, Baton Rouge, LA (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/619,598

(22) Filed: Jan. 3, 2007

(51) Int. Cl. H04N 5/225

(52) U.S. Cl. 348/373

(57) ABSTRACT

The present invention a gooseneck video device holder, consisting of a cradle for holding a personal video device attached to a flexible member, or “gooseneck” for multiple positioning possibilities, and thus is adaptable for a multitude of viewing positions and users.

### BACKGROUND OF THE INVENTION

The present invention relates to an apparatus that can be used to hold and position a personal video device for comfortable viewing and use without the need for the employment of a user's hands.

Currently, there are a large number of personal video devices such as Apple®'s iPod®, or Microsoft's® Zune® which enable a user to download video data and view it on the device from any location free of wires, cables or connectivity. Such devices typically are, by design, small in size for portability, contain a storage medium for the video data to be kept (such as flash memory or a hard drive), as well as a small video screen upon which to view the video and informational messages.

While the ability to view videos on demand is certainly a benefit, obvious downsides to the current mode of viewing these videos on such small devices exist. The size of the screen necessitates the viewer to be relatively close to the screen in order to be able to appreciate the detail and images contained thereon. Holding the personal video device can be tiresome for long periods of time, particularly with the advent of being able to view full feature-length films on these personal video devices which can easily exceed ninety minutes. A user's arms may not be able to position the device within viewable range for such periods of time without becoming fatigued, and typically there is not a location upon which to set the device to view the same. Without holding the device close to the user's field of vision, it is difficult to see detail, particularly on the smallest devices whose screens measure less than two inches diagonally. Thus when it comes to viewing a personal video device, extended viewing sessions are difficult, if not impossible, to comfortably achieve. This is especially true of those users who may have some visual impairment, such as near- or far-sightedness.

The consequence of these issues is decreased enjoyment of the video and/or device, or very simply, a user's under-utilization of the ability to view video for lack of a comfortable way to do so.

The present invention of a gooseneck video device holder is thus a much-improved apparatus for watching video on these devices, as it requires neither the use of a person's hands nor a fixed place to put a personal video device, and improves most every aspect of the viewing of videos on these devices, and in many cases, enables what was impossible before due to ergonomic constraints.

All of these aspects of the current mode of viewing videos on a personal video device lead to an increased need for an apparatus for viewing these videos with minimized cost and complexity, all of which the present invention addresses.

### OBJECTS OF THE INVENTION

One object of the invention is to provide a device that enables a user to view a personal video device without his or her hands.

Another object of this invention is to provide a more comfortable way to view video on a personal video device.

Yet another object of this invention is to provide an economical apparatus for watching videos on a personal video device.

Still another object of this invention is to provide a positionable holder for a personal video device.

Other objects and advantages of this invention shall become apparent from the ensuing descriptions of the invention.

### SUMMARY OF THE INVENTION

According to the present invention, a gooseneck video device holder is disclosed; consisting of a cradle for holding a personal video device attached to a flexible member, or “gooseneck” for multiple positioning possibilities, and thus is adaptable for a multitude of viewing positions and users.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a perspective view of the gooseneck video device holder.

FIG. 2 is a perspective view of the gooseneck video device holder having an optional clamp attachment.

FIG. 3 is a perspective view of the gooseneck video device holder being used around a user's neck.

FIG. 4 is a perspective view of the gooseneck video device holder in use while a user is lying prostrate.

### DETAILED DESCRIPTION OF EXEMPLARY EMBODIMENTS

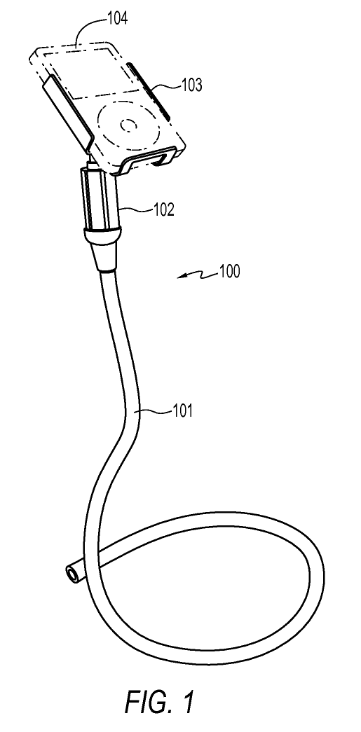

Without any intent to limit the scope of this invention, reference is made to the figures in describing the various embodiments of the invention. FIGS. 1-4 show various aspects of exemplary embodiments of the present invention.

The present invention relates to a gooseneck video device holder 100, which is comprised mainly of two portions, an elongated flexible member 101, known herein as a gooseneck, having opposite ends, one of which is attached to pivoting apparatus 102. Pivoting apparatus 102 can be of various configurations, such as a ball-bearing, ball and socket joint, or any other number of configurations, both known and unknown in the art, which enable the multiple fixed position of two adjoining components.

Pivoting apparatus 102 may be attached to flexible member 101, or “gooseneck attachment” by any number of means, such as a threaded attachment, adhesive-based attachment, or may be cast together with pivoting apparatus 102. Flexible member 101 is constructed in such a fashion that it holds its form as manipulated by a user, or in other words, stays in the configuration chosen by a user. This feature is especially important to the invention, since it is this ability for flexible member 101 to hold its shape which gives it the versatility required to assume the various positions described herein.

Flexible member 101 can be constructed in many ways, such as an extrusion of flexible plastic, casting of rubber, or series of small sections which permit incremental movement and positioning. This type of member simultaneously provides support, adjustability and obedience, or the ability to remain in place. It is essential to this invention that flexible member 101 be of sufficient length to be wrapped around a user or other object as described elsewhere herein.

On the opposing end of pivoting apparatus 102 from flexible member 101 is cradle 103 which is shaped to receive personal video device 104. Personal video device 104 can be any number of devices known in the art, or devices developed in the future which serve the same or similar function.

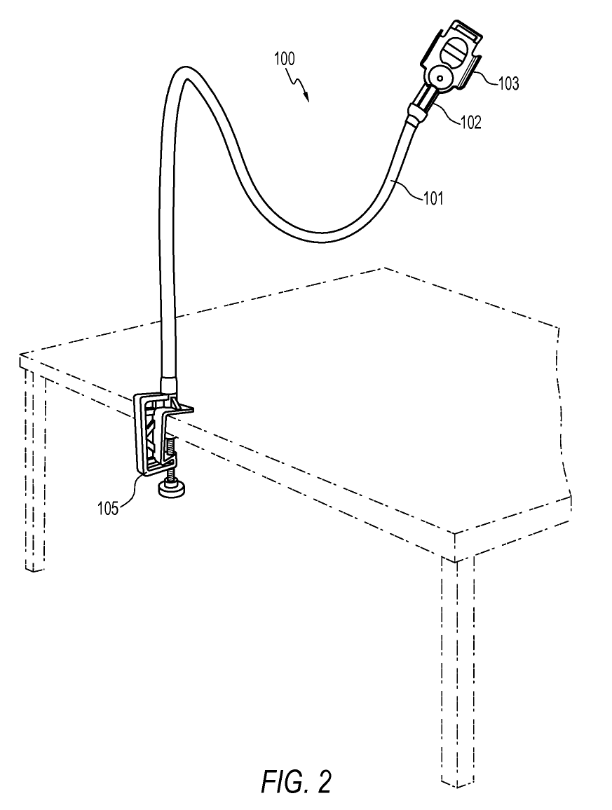

In another exemplary embodiment as illustrated in FIG. 2, clamp 105 may be employed on the second opposite end of flexible member 101 so that the video device holder 100 may be affixed to a stationary object, such as a table desk, chair, airline tray, dashboard or the like.

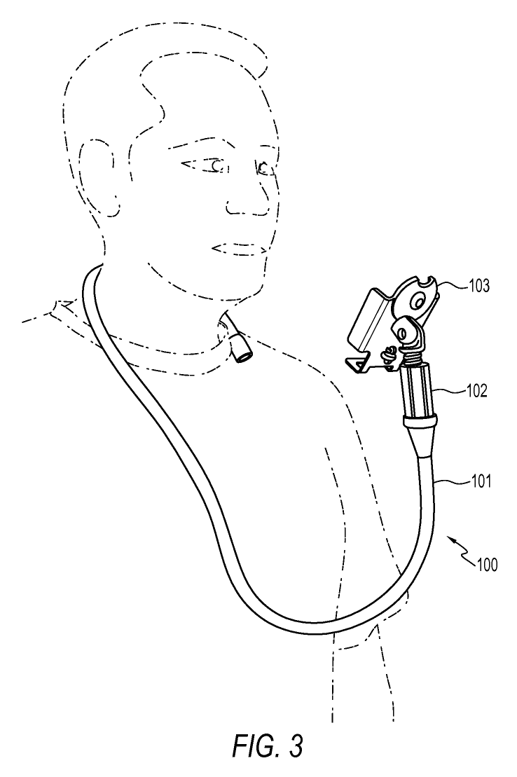

In operation, then, a user will place personal video device 104 into cradle 103 to secure the device. Then, flexible member 101 is positioned into the desired configuration, such as around a user's neck, arm or other structure, as shown in the example in FIG. 3. Once the desired configuration is achieved, pivoting apparatus 102 can then be manipulated to fine tune the angle of which the user desires to view personal video device 104.

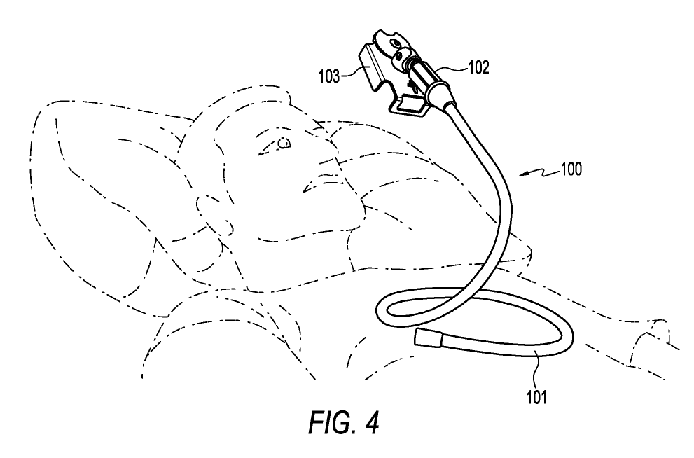

As an alternative, flexible member 101 can be coiled and made into an independent stand which can be placed on a user's stomach or chest while in use, such as the configuration shown in FIG. 4. It should be noted that these configurations can be used to place the device on a flat surface, or attach to any other inanimate object, such as a desk lamp arm, chair arm, shelf or the like.

In the other exemplary embodiment shown in FIG. 2, clamp 105 would be secured to a stationary object such as those described above before positioning. This configuration is useful for a user who has a stationary object at his disposal and wishes to be able to maneuver independently of video device holder 100.

The ability of the pivoting apparatus 102 to be arranged in a fixed position complements the ability of flexible member 101 to be similarly arranged in a fixed position. In this fashion, flexible member 101 and pivoting apparatus 102 can be used in concert to achieve an infinite number of viewing positions by the user, of which multiple positions may be comfortable and desired by a user. This positioning can be changed infinitely as well, depending on product life, so a user's desire to change position or viewing angle can be easily accommodated.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A gooseneck video device holder comprising:
a handheld video device;
a cradle operatively configured to secure the video device, the cradle comprising:
a back member, having a proximal side and a distal side which is approximately rectangular in shape and adapted to receive the video device;
a left side member integrated approximately perpendicularly and extending proximally from a long edge of the back member for securing a side of the video device;
a right side member integrated approximately perpendicularly and extending proximally from a long edge of the back member such that the right edge is parallel to the left edge;
a bottom member integrated approximately perpendicularly and extending proximally from a short edge of the back member such that the bottom member is perpendicular to the left side member and the right side member; and
an adapter pivotally connected to the distal side of the back member such that the back member can pivot in relation to the adapter;
an elongated flexible member comprised of positional plastic having first and second opposite ends, wherein the first opposite end is pivotally affixed to the adapter of the cradle and whereby the elongated flexible member holds its form as the shape of the elongated flexible member is manipulated; and
a clamp integrated with the second opposite end of the elongated flexible member.

2-5. (canceled)

6. A gooseneck video device holder comprising:
a cradle for holding a video device;
an elongated flexible member having a first and second opposite ends whereby the flexible member holds its form as the shape of the elongated flexible member is manipulated; and
an adapter interconnecting the cradle to the elongated flexible member.

7. The gooseneck video device holder of claim 6 whereby the cradle further comprises:
a back member, having a proximal side and a distal side which is approximately rectangular in shape and adapted to receive a video device;
a left side member integrated approximately perpendicularly and extending proximally from a long edge of the back member for securing a side of the video device;
a right side member integrated approximately perpendicularly and extending proximally from a long edge of the back member such that the right edge is parallel to the left edge; and
a bottom member integrated approximately perpendicularly and extending proximally from a short edge of the back member such that the bottom member is perpendicular to the left side member and the right side member.

8. The gooseneck video device holder of claim 6 wherein the adapter is a ball-bearing.

9. The gooseneck video device holder of claim 6 wherein the flexible member is positionable plastic.

10. The gooseneck vide device holder of claim 6 wherein the flexible member is comprised of multiple interlocking sections.

11. The gooseneck video device holder of claim 6 further comprising a clamp operatively attached to the second opposite end and configured to attach to a stationary object.

12. The gooseneck video device holder of claim 6 wherein the flexible member is casting of rubber.

13. The gooseneck video device holder of claim 6 wherein the flexible member is a series of small sections which permit incremental movement and positioning.

14. A method of watching a vide device comprising:
attaching the video device to a cradle configured to received the video device, whereby the cradle is operatively connected to an elongated flexible member whereby the elongated flexible member holds its form as the shape of the elongated flexible member is manipulated;
positioning the elongated flexible member; and
tilting the cradle so as to position the video device for a user to watch a video.

15. The method of claim 14 whereby the step of positioning the elongated flexible member comprises coiling an end of the elongated flexible member so as to allow the elongated flexible member to stand independently whilst holding the video device.

16. The method of claim 15 further comprising the steps of:
a user laying on his or her back; and
placing the coiled elongated flexible member upon the user's chest so as to position the cradle such that the video device is presented in front of the user's face.

17. The method of claim 14 further comprising the steps of:
attaching a clamp to an end of the elongated flexible member; and
clamping the clamp to a stationary object.

18. The method of claim 17 whereby the stationary object is selected from the group comprising a desk, a table, a chair, or a shelf.

19. The method of claim 14 whereby the step of positioning the elongated flexible member comprises coiling an end of the elongated flexible member around a user's neck so as to position the cradle such that the video device is presented in front of the user's face.
